(19) United States
(12) Patent Application Publication
(10) Pub. No.: US 2023/0381767 A1
(43) Pub. Date: Nov. 30, 2023

(54) CATALYTIC BED COMPRISING A PARTICULAR PHOTOCATALYTIC CATALYST

(71) Applicant: IFP Energies Nouvelles, Rueil-Malmaison (FR)

(72) Inventors: Celine PAGIS, Rueil-Malmaison (FR); Audrey BONDUELLE SKRZYPCZAK, Rueil-Malmaison (FR)

(73) Assignee: IFP Energies Nouvelles, Rueil-Malmaison (FR)

(21) Appl. No.: 18/031,728

(22) PCT Filed: Oct. 6, 2021
(86) PCT No.: PCT/EP2021/077607

§ 371 Date: Apr. 13, 2023

(30) Foreign Application Priority Data
Oct. 15, 2020 (FR) FR2010561

(51) Int. Cl. B01J 35/00; B01J 35/02; B01J 37/02; B01J 21/06; B01J 21/08; B01J 35/08; B01D 53/86; B01D 53/88

(52) U.S. Cl. CPC B01J 35/004; B01J 35/023; B01J 37/0201; B01J 21/063; B01J 21/08; B01J 35/08; B01D 53/8671; B01D 53/885; B01D 2255/20707; B01D 2255/802; B01D 2257/504

(57) ABSTRACT

The present invention relates to a catalytic bed comprising a particular photocatalytic catalyst. The bed comprises structuring particlesa made of inorganic material, b, combined with at least one semiconductor material, a, with photocatalytic properties, the combination being produced by mixing structuring particles made of inorganic material, b, with the semiconductor material, a, in the form of particles, —and/or by chemical or physicochemical deposition of the semiconductor material, a, on the structuring particles made of inorganic material, b, the structuring particles, b, being of substantially spherical shape and of mean diameter between 22 nm and 8.0 μm.

### TECHNICAL FIELD

The present invention relates to the field of photocatalysis, targeted at treating liquid or gas phases by bringing into contact with a photocatalytic material, which will be irradiated with a source emitting in an appropriate wavelength range. It relates more particularly to a new type of photocatalytic material, to its method of preparation and to its applications.

### PRIOR ART

Photocatalysis is based on the principle of activation of a semiconductor acting as photocatalyst using the energy provided by irradiation. A semiconductor is characterized by its band gap, i.e. by the energy difference between its conduction band and its valence band, which is specific to it. Photocatalysis can be defined as the absorption of a photon, the energy of which is greater than the band gap width between the valence band and the conduction band, which induces the formation of an electron-hole pair in the case of a semiconductor. There is thus excitation of an electron to the conduction band and formation of a hole on the valence band. This electron-hole pair will make possible the formation of free radicals which will either react with compounds present in the medium, in order to initiate oxidation/reduction reactions, or else recombine according to various mechanisms. Any photon having an energy greater than its band gap can be absorbed by the semiconductor. No photon with an energy lower than its band gap can be absorbed by the semiconductor.

The fields of application are vast: Photocatalysis can thus be used to operate the decontamination of gaseous media, in particular to convert, by oxidation, compounds of the VOC (acronym for Volatile Organic Compounds) type, or to treat liquid media, containing for example toluene, benzene, ethanol or acetone. Photocatalysis can also be used to convert, by reduction, the CO₂ of a gaseous medium, in order to convert it into upgradable compounds, in particular with one or more carbons, such as CO, methane, methanol, carboxylic acids, ketones or other alcohols: the CO₂ will thus be actively converted rather than being captured and stored to reduce the content thereof in the atmosphere. It is also possible to carry out a photolysis of the water of a liquid or gaseous medium, to produce upgradable hydrogen H₂, in particular as low-carbon energy source.

There is known, from the patent WO2018/197432, a photocatalytic material in the form of a porous monolith containing from 20% to 70% by weight of TiO₂, with respect to the total weight of the monolith, and from 30% to 80% by weight of a refractory oxide chosen from silica, alumina or silica-alumina, with respect to the total weight of the monolith, and having a bulk density of less than 0.19 g/ml, with a specific porosity, in particular in terms of macro- and mesoporosities. This thus concerns a material which combines, with a semiconductor which is the source of its photocatalytic properties (titanium oxide), one or two refractory oxides, with in addition a particular porosity leading to photocatalytic performance qualities which are superior to those which would be obtained with a material entirely constituted of titanium oxide.

A subject matter of the invention is consequently the development of a photocatalytic material which is improved, in particular in terms of photocatalytic performance qualities which are further improved, and additionally of improved implementation and/or production.

### SUMMARY OF THE INVENTION

The invention relates first of all to a catalytic bed comprising a particulate photocatalytic catalyst, said bed comprising structuring particles made of mineral material b which are combined with at least one semiconductor material a having photocatalytic properties, the combination being produced
by mixing the structuring particles made of mineral material b with the semiconductor material a in the form of particles,
and/or by chemical or physicochemical deposition of the semiconductor material a on the structuring particles made of mineral material b,
   the structuring particles b being essentially spherical in shape and having a mean diameter of between 22 nm and 8.0 μm, and preferably between 30 nm and 7.5 μm.

The mineral material targeted by the invention is of electrical insulator type, thus essentially inert with respect to photocatalysis: it is a material, the band gap of which is greater than 6 eV.

Preferably, this catalytic bed is intended to be a fixed bed (as opposed, in particular, to a fluidized bed).

The invention has thus chosen to disperse the semiconductor material in a mineral material which is not it, by calibrating the size of the particles of this mineral material as a function of the range of wavelengths targeted for the irradiation of the semiconductor material which will make possible the creation of electron-hole pairs and thus the desired photocatalytic reactions. This is because, conventionally in the field of photocatalysis, irradiation sources are chosen in the UV-A, UV-B and/or visible range, which define a range of wavelengths capable of activating conventional semiconductor materials, such as titanium oxide.

In point of fact, the invention, by choosing particles, called here structuring particles, made of mineral material which are both spherical and with a specific mean diameter, makes use of what is known under the term of Mie scattering, by causing optimum scattering of the radiation, preferentially in the direction of the incident radiation: the Mie scattering is directly linked to the wavelength of the incident radiation and denotes the preferential scattering of the radiation in its incident axis for spherical particles, the radius of which is between 0.1 and 10 times the wavelength in question. The structuring particles of the invention, with their accordingly adjusted diameters, will thus amplify the effectiveness of the irradiation in the range from UV-A rays up to the visible range: they will scatter the radiation mainly in the incident direction from the surface of the catalytic bed, and thus considerably increase the possibilities of the semiconductor material being irradiated, thus increasing its photocatalytic capabilities. This is because the depth of penetration of the incident radiation within the catalytic bed will be greater, it then being possible for the radiation to reach areas of semiconductor material which are otherwise difficult to reach by the radiation.

It has been discovered that the photocatalytic performance qualities of the material could be increased by a factor of 2, indeed even 3 or 4, indeed even, in the most favorable configurations, by a factor of 10 and more, in comparison with a material composed in the same way but with particles outside this diameter range and/or which are non-spherical, which gives a great deal of flexibility in the implementation of the invention. Thus, it is possible to choose to amplify the performance qualities of the material as much as possible, with an identical amount of semiconductor, or to amplify it to a lesser extent, or to keep it at the very least identical while reducing the amount of semiconductor in the material, depending on whether the performance quality or the cost of the catalyst is favored.

The invention provides two alternative or cumulative variants for constituting the material, and they both have their advantages:

The variant with two types of particles, the structuring ones and the semiconductor ones, is advantageous because it is simple to produce, since it is not sought to render the two types of material integral and since the preparation is based only on a mixing of the two powders, without chemical reaction, heat treatment, and the like. This variant also allows for very easy adaptation to any shape and any dimensions of catalytic bed. It makes it possible to form the bed in situ, directly in the reactor in which the bed has to be placed, without prior pre-conditioning, by easily adapting, on a case-by-case basis, the proportion between the two types of particles in particular, except for providing the devices appropriate for ensuring as homogeneous a mixing as possible between the two types of particles. It is also possible to provide for conditioning the mixture beforehand, in order to have only one product to be deposited to form the bed.

The other variant, which consists in chemically/physicochemically depositing the semiconductor on the structuring particles, also exhibits advantages: it ensures a controlled distribution of the semiconductor with respect to the particles, an integration between the two materials which favors their interactions, in particular in this instance with regard to the radiation scattered by the particles. It thus offers a “ready-to-use” product for forming catalytic beds in reactors. It should be noted that the structuring particles can be completely or only partially covered by the semiconductor. It should also be noted that, according to this variant, provision can also be made for a certain proportion of the structuring particles to remain devoid of deposit of semiconductor material.

Advantageously, the structuring particles are (essentially) spherical and solid: that they are solid gives them better mechanical properties, better mechanical strength, abrasion resistance, attrition resistance, and the like.

Preferably, all of the particles within the bed are arranged in a disorganized manner. This is because it has turned out, surprisingly, that this disorganization was beneficial in terms of photocatalytic performance qualities of the material. The term “disorganized” is understood to mean the fact that the particles of the material are not lined up in an orderly fashion, do not form layers of particles aligned in three dimensions. The material according to the invention thus exhibits intergrain spaces of nonuniform sizes and locations, positioned randomly within the material. In addition, these spaces are different depending on whether either the variant of mixtures of particles (of different size and shape) or the variant with only one particle type (the structuring particles covered at least partially with semiconductor) is involved.

Preferably, when the bed contains the semiconductor material a in the form of particles, said particles exhibit a mean dimension of at most 100 nm, in particular of at most 50 nm, and of at least 5 nm, preferably of between 10 and 30 nm. It should be noted that, in this case, these particles are not spherical, or not necessarily so, and their mean dimension is not conditioned by the wavelength of the irradiating radiation.

Preferably, the catalytic bed according to the invention exhibits a void ratio, equal to the ratio of the void volume in the photocatalytic bed to the total volume of the bed composed of voids and of particles, of at least 40%, preferably of at most 80% and in particular of between 40% and 70%. This void ratio is, indirectly, an indication of the disorganized arrangement of the material mentioned above. This is because the void ratio is minimal when perfectly organized spheres are concerned, and the void ratio according to the invention is greater than this minimal ratio.

Preferably, the catalytic bed according to the invention exhibits a “dilution ratio”, equal to the ratio of the volume occupied by structuring particles made of mineral material b to the volume occupied by the sum of the semiconductor material(s) a, a′ and of the structuring particles made of mineral material b, of at most 80%, in particular of between 5% and 70%, and preferably of between 10% and 50%. This dilution ratio of at most 80% is chosen in particular in the case of a chemical or physicochemical deposition of the semiconductor material a on the structuring particles made of mineral material b, but can naturally apply to both variants of the invention.

This term “dilution ratio” is used to reflect the proportion of the active material (the semiconductor) with respect to the structuring particles, which, a priori, are not or hardly at all active. The higher this dilution ratio, the greater the amount of structuring particles. From the examples set out later, it will be seen that this dilution ratio can be increased without decreasing, indeed even while enhancing, the photocatalytic performance qualities of the material as a whole. It is more judicious to reason in dilution ratio by volume than by mass, insofar as the density of the materials, in particular of the semiconductor, can vary widely from one semiconductor to another.

In one embodiment of the invention, the catalytic bed can comprise (at least) two distinct semiconductor materials, a first material a and a second material a′. It can be produced:
by mixing structuring particles made of mineral material b with the semiconductor material(s) each in the form of particles of the first material a and of particles of the second material a′,
and/or by chemical or physicochemical deposition of the semiconductor materials a, a′ on the support particles b, either by deposition both of the first semiconductor material a and of the second semiconductor material a′ on the structuring particles b, or by deposition of the first semiconductor material a on a first part of the structuring particles b and of the second semiconductor material a′ on a second part of the structuring particles b.

There are thus either three powders to be mixed of three different materials, a, a′ and b, i.e. two powders b+a and b+a′ (the structuring particles covered either with the first semiconductor or with the second), or a single powder b+a+a′ (the structuring particles covered with both the first and the second semiconductors).

Naturally, it is possible to use more than two different semiconductor materials, on the same principle. And there also remains the option of the bed containing, in addition, a certain portion of structuring particles not covered with semiconductor material, in the variant where the semiconductors are deposited at their surface.

Advantageously, the structuring particles made of mineral material b can be made of metal oxide(s), in particular made of oxides of metals of groups IIIa and IVa of the periodic table, and preferably chosen from aluminum oxide, silicon oxide, a mixture of aluminum and silicon oxides.

Advantageously, the/at least one of the semiconductor material(s) a, a′ can be chosen from inorganic semiconductors. The inorganic semiconductors can be chosen from one or more elements of group IVa, such as silicon, germanium, silicon carbide or silicon-germanium. They can also be composed of elements of groups IIIa and Va, such as GaP, GaN, InP and InGaAs, or of elements of groups IIb and VIa, such as CdS, ZnO and ZnS, or of elements of groups Ib and VIIa, such as CuCl and AgBr, or of elements of groups IVa and VIa, such as PbS, PbO, SnS and PbSnTe, or of elements of groups Va and VIa, such as Bi₂Te₃ and Bi₂O₃, or of elements of groups IIb and Va, such as Cd₃P₂, Zn₃P₂ and Zn₃ As₂, or of elements of groups Ib and VIa, such as CuO, Cu₂O and Ag₂S, or of elements of groups VIIIb and VIa, such as CoO, PdO, Fe₂O₃ and NiO, or of elements of groups VIb and VIa, such as MoS₂ and WO₃, or of elements of groups Vb and VIa, such as V₂O₅ and Nbr₂O₅, or of elements of groups IVb and VIa, such as TiO₂ and HfS₂, or of elements of groups IIIa and VIa, such as In₂O₃ and In₂S₃, or of elements of groups VIa and of the lanthanides, such as Ce₂O₃, Pr₂O₃, Sm₂S₃, Tb₂S₃ and La₂S₃, or of elements of groups VIa and of the actinides, such as UO₂ and UO₃.

Preferably, they comprise at least one of the following metal oxides: titanium oxide, tungsten oxide, cerium oxide, bismuth oxide, zinc oxide, copper oxide, vanadium oxide, iron oxide, cadmium oxide, and preferably is chosen from TiO₂, Bi₂O₃, CdO, Ce₂O₃, CeO₂, CeAiO₃, CuO, Fe₂O₃, FeTiO₃, ZnFe₂O₃, V₂O₅, ZnO, WO₃ and ZnFe₂O₄, alone or as a mixture.

The/at least one of the semiconductor material(s) a, a′ can be doped with one or more ions chosen from metal ions, in particular ions of V, Ni, Cr, Mo, Fe, Sn, Mn, Co, Re, Nb, Sb, La, Ce, Ta, Ti, or from non-metal ions, in particular C, N, S, F, P, or by a mixture of metal and non-metal ions.

The/at least one of the semiconductor material(s) a, a′ can also comprise one or more element(s) in the metallic state chosen from an element of groups IVb, Vb, VIb, VIIb, VIIIb, Ib, IIb, IIIa, IVa and Va of the periodic table of the elements and preferably in direct contact with said semiconductor material. It is preferentially a metal from platinum, palladium, gold, nickel, cobalt, ruthenium, silver, copper, rhenium or rhodium.

It should be noted that, throughout this text, the groups of chemical elements are given according to the CAS IUPAC classification (CRC Handbook of Chemistry and Physics, publisher CRC Press, 81st edition, 2000-2001) rather than according to the new classification. For example, group VIII according to the CAS classification corresponds to the metals of columns 8, 9 and 10 according to the new IUPAC classification.

The catalytic bed according to the invention can exhibit a thickness of at most 1 cm, in particular of at most 5 mm, and in particular of at least 10 μm. Preferably, its thickness is at least 100 or 200 microns. This thickness depends in particular on the depth of penetration of the radiation from the irradiation source into the bed.

Another subject matter of the invention is a process for obtaining the catalytic bed as defined above, where, on the one hand, the structuring particles of mineral material b and, on the other hand, the particles of semiconductor material a are mixed so as to produce a homogeneous distribution of the two types of particles within the bed. Devices exist, both on the laboratory scale and on the industrial scale, of screw mixer/mill type, to ensure homogeneous mixing.

Another subject matter of the invention is a process for obtaining the catalytic bed as defined above, where the or at least one of the semiconductor material(s) a, a′ is deposited on the structuring particles of mineral material b by impregnation of said structuring particles with a solution of at least one precursor of the semiconductor material, or by ion exchange, or by the electrochemical route of the type in particular with molten salts, then drying and optional calcination. It is also possible to choose a chemical vapor deposition (CVD), spray drying or atomic layer deposition (ALD), or any other technique known to the specialist in depositions of this type.

Another subject matter of the invention is any reactor for the photocatalytic treatment of a feedstock in gaseous and/or liquid form and which comprises at least one photocatalytic bed as defined above and which is mounted in a fixed manner in said reactor. This is because it is when the bed is fixed (as opposed to the moving bed reactors) that the benefits of Mie scattering on the structuring particles can be best taken advantage of.

Another subject matter of the invention is a process for the photocatalytic treatment of a feedstock in gaseous or liquid form, such that:
at least one photocatalytic bed defined above is arranged in a fixed manner in a reactor,
said feedstock is brought into contact in the reactor with the catalytic bed,
and the photocatalytic bed, during the contacting operation, is irradiated with at least one irradiation source emitting in the UVA-A range and/the UV-B range and/or the visible range, in particular in the wavelength range of between 220 and 800 nm, preferably in the range of between 300 and 750 nm.

Another subject matter of the invention is such a process, where the photocatalytic treatment is:
a photo-oxidation of components present in a liquid or gaseous feedstock, in particular for the purposes of depollution/decontamination of the feedstock,
or a photocatalytic reduction of the CO₂ of a liquid or gaseous feedstock,
or a photolysis of the water of a liquid or gaseous feedstock, for the purposes of producing H₂.

### LIST OF THE FIGURES

FIG. 1 represents a diagrammatic re-emission pattern of an incident beam on particles according to a Rayleigh-type scattering and according to a Mie-type scattering.

FIG. 2 represents a transmission electron microscopy (TEM) image of the semiconductor particles made of titanium oxide used according to an embodiment of the photocatalytic material according to the invention.

FIG. 3 represents a scanning electron microscopy (SEM) image of the structuring particles made of silicon oxide used according to an embodiment of the photocatalytic material according to the invention.

FIG. 4 represents a simplified diagram of an installation targeted at measuring the performance qualities of a photocatalytic material according to the invention.

FIG. 5 represents a graph quantifying photocatalytic performance qualities of two examples of material according to the invention, with, on the abscissa, the fraction by volume of semiconductor made of titanium oxide of the material of the invention comprising this semiconductor and structuring particles made of silicon oxide and, on the ordinate, the overall consumption of electrons for 20 hours per square meter, expressed in μmol/m².

### DESCRIPTION OF THE EMBODIMENTS

The invention relates to the composition of a photocatalytic bed with mineral structuring particles, in this instance solid ones, which are calibrated according to the wavelength of the radiation emitted by a light source in order to activate a semiconductor material, so that the radiation scatters largely preferentially in the direction of the radiation incident to the surface of these spheres by making use of Mie scattering.

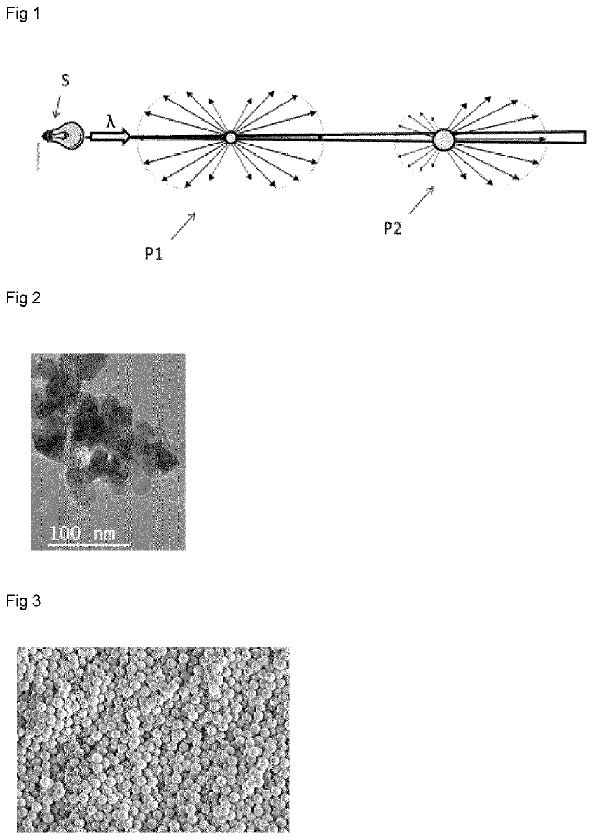

Thus, FIG. 1 diagrammatically represents simply the phenomenon of Mie scattering mentioned above: on the left is symbolically represented a light source S emitting radiation in a given wavelength λ. A spherical particle P1, the diameter of which is not calibrated according to the invention, and which is less than 0.1 λ, will fairly evenly re-emit the incident radiation in all directions; this is Rayleigh scattering. On the other hand, a particle P2, the diameter of which is calibrated to be between 0.1 λ and 10 λ, will re-emit the radiation in a favored manner along the direction of the incident radiation; this is Mie scattering. This is what the invention uses, so that the calibrated particles “lead” more radiation into the depth of the catalytic bed, that it facilitates its propagation, and that the semiconductor material is thus made better use of.

The semiconductor material combined with these particles then experiences an astonishing increase in its photocatalytic activity. This activity can be made use of in all the known fields of activity of photocatalysis of liquid and/or gaseous fluids. It can be the reduction of CO₂, the photocatalytic production of H₂ by photoconversion of water (which is also denoted under the term of “water-splitting”), or also the photocatalytic decontamination of air (conversion of VOCs) or of water.

The invention will be illustrated below by nonlimiting examples, using different photocatalytic materials and different structuring particles:

### Photocatalytic Material

The photocatalytic material al is titanium oxide: it is TiO₂ available under the trade name Aeroxide® P25 from Aldrich, with a purity of 99.5%. The titanium oxide is in the form of fine particles. Its particle size, measured by transmission electron microscopy (TEM), is 21 nm. Its specific surface, measured by the BET method, is 52 m²/g. BET is an abbreviated term: it is the Brunauer-Emmett-Teller method as defined in S. Brunauer, P. H. Emmett and E. Teller, J. Am. Chem. Soc., 1938, 60 (2), pp 309-319.

Crystallographically, this titanium oxide is in the form of a mixture of rutile and anatase.

FIG. 2 is a representation obtained by TEM of these titanium oxide particles: it is seen that they are of irregular shape and that they tend to agglomerate.
The photocatalytic material a2 is titanium oxide with the addition of platinum metal particles prepared by photodeposition in the following way:

0.0712 g of H₂PtCl₆.6H₂O (37.5% by weight of metal) is introduced into 500 ml of distilled water. ml of this solution are withdrawn and inserted into a jacketed glass reactor. 3 ml of methanol, followed by 250 mg of TiO₂ of the al type (Aeroxide® P25, Aldrich™, purity >99.5%), are then added with stirring to form a suspension.

The mixture is then left with stirring and under UV radiation for two hours. The lamp used to supply the UV radiation is a 125 W HPK™ mercury vapor lamp. The mixture is subsequently centrifuged for 10 minutes at 3000 revolutions per minute in order to recover the solid. Two washing operations with water are subsequently carried out, each of the washing operations being followed by a centrifugation. The recovered powder is finally placed in an oven at 70° C. for 24 hours.

The photocatalytic material a2 is then obtained. The content of Pt element is measured by inductively coupled plasma-atomic emission spectroscopy (ICP-AES) at 0.99% by weight.
The photocatalytic material a3 is a commercial semiconductor based on WO₃ (available from Sigma-Aldrich, exhibiting a particle size of less than 100 nm). The specific surface, measured by the BET method, is equal to 20 m²/g. The photocatalytic material particle size, measured by X-ray diffractometry (Debye-Scherrer method), is 50±5 nm.
The photocatalytic material a4 is a mixture of titanium and copper oxides, with particles of platinum Cu₂O/Pt/TiO₂. It is prepared in the following way:

A solution of Cu(NO₃)₂ is prepared by dissolving 0.125 g of Cu(NO₃)₂.3H₂O (Sigma-Aldrich™, 98%) in 50 ml of a 50/50 isopropanol/H₂O mixture, i.e. a concentration of Cu₂₊ of 10.4 mmol/l.

The following were introduced into the reactor: 0.20 g of the photocatalytic material a2, 25 ml of distilled water and finally 25 ml of isopropanol. The system is purged in the dark under a stream of argon (100 ml/min) for 2 h. The reactor is thermostatically controlled at 25° C. throughout the synthesis.

The stream of argon is subsequently slowed down to 30 ml/min and the irradiation of the reaction mixture starts. The lamp used to provide the UV radiation is a 125 W HPK™ mercury vapor lamp. Then, the 50 ml of copper nitrate solution are added to the mixture. The mixture is left stirring and under irradiation for 10 hours. The mixture is subsequently centrifuged for 10 minutes at 3000 revolutions per minute in order to recover the solid. Two washing operations with water are subsequently carried out, each of the washing operations being followed by a centrifugation. The recovered powder is finally placed in an oven at 70° C. for 24 hours.

The photocatalytic material a4, Cu₂O/Pt/TiO₂, is then obtained. The content of Cu element is measured by ICP-AES at 2.2% by weight. By XPS (X-Ray Photoelectron Spectrometry) measurement, and copper oxide phases at 67% of Cu₂O and 33% of CuO.

### Structuring Particles

The structuring particles b1 chosen in some of the following examples are spherical particles made of silicon oxide based on commercial SiO₂, which can be obtained from Alfa Aesar (CAS: 7631-86-9): these are beads with a purity of greater than 99.9%, and the mean diameter of which, measured by laser particle size analysis, is 0.4 μm.

FIG. 3 is a representation obtained by SEM of these beads, which are actually seen to be very homogeneous in their size and their shape.
The structuring particles b2 chosen in other examples are particles made of silicon oxide based on commercial SiO₂, which can be obtained from Sigma-Aldrich, under the commercial reference Davisil Grade 710, 10-14 μm: these are beads with a purity of greater than 99%, and the mean dimension of which, measured by laser particle size analysis, is 12.7 μm (distribution by volume).

The semiconductor particles a1 to a4 and the structuring particles b1 (SiO₂ powder) or b2 (SiO₂ powder with a greater particle size than that of b1) are mechanically mixed with a dilution ratio varying from 0% to 75% by volume, so as to obtain a homogeneous distribution of the two types of particles in the material. It is recalled that, within the meaning of the present invention, the “dilution ratio” is equal to the ratio of the volume occupied by the structuring particles made of mineral material to the volume occupied by the sum of the semiconductor material(s) and of the structuring particles.

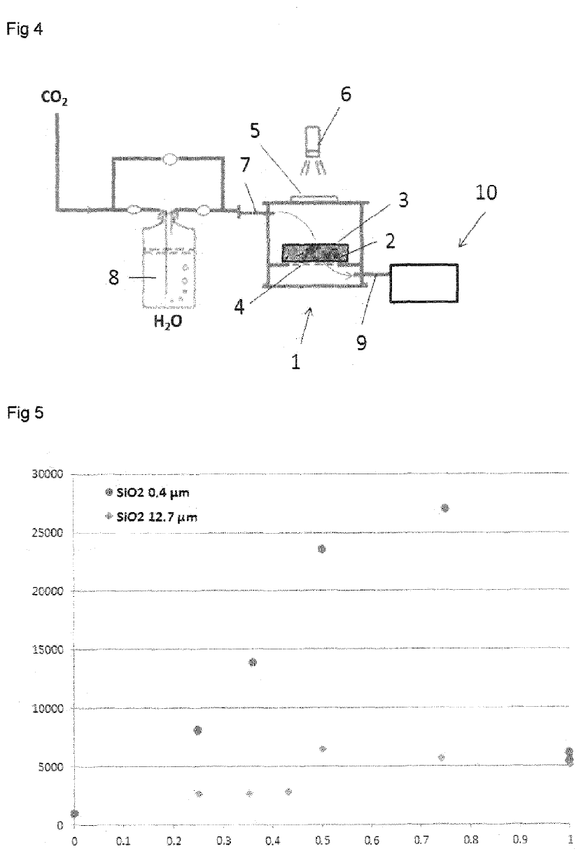

Subsequently, as represented in FIG. 4, each sample 3 of photocatalytic material of each example is subjected to a test of photocatalytic reduction of CO₂ in the gas phase in the following way: Use is made of a reactor 1, which operates continuously, with a fixed bed 2 arranged horizontally in its cavity, which bed comprises a sintered material 4 on which the sample 3 is placed. The reactor 1 exhibits, in its upper wall, an optical window made of quartz facing which is found the sample 3. Above the reactor, and facing the window 5, is arranged a source of UV-visible irradiation 6.

In operation, the reactor 1 is fed via an inlet in the top part with a stream 7 of gaseous CO₂, which is bubbled beforehand into a container/saturator filled with water 8. The stream 7 passes through the sample 3 and is then discharged via an outlet in the bottom part in the form of a stream 9 which is analyzed in-line by a gas analyzer 10 of micro gas chromatograph type.

The UV-visible irradiation source 6 is a xenon lamp, available from Asahi under the trade name MAX 303.

The tests are carried out on samples 3 amounting to between 45 and 70 mg, their weight varying according to their chosen dilution ratio, the thickness of the catalytic bed 2, thus that of the sample 3, remaining fixed and equal to 0.3 mm.

The operating conditions are as follows:
ambient temperature
atmospheric pressure
flow rate 7 of CO₂ passing through the water saturator 8 of 18 ml/h
duration of the test for each sample: 20 h
irradiation power of the xenon lamp 6: kept constant at 80 W/m², measured for a wavelength range of between 315 and 400 nm.

The targeted conversion of the CO₂ corresponds to the following reaction:

CO₂+H₂O+hv→O₂+H₂, CO, CH₄, C₂H₆

The measurement of the photocatalytic performance qualities of the samples is carried out by micro chromatography with the device 10, the production of H₂, of CH₄ and of CO which result from the reduction of CO₂ and of H₂ O being monitored by an analysis every 6 minutes. Products of the reduction of CO₂ are identified, such as CO, methane or also ethane. The mean photocatalytic activities are expressed in μmol of photogenerated electrons which are consumed by the reaction over the duration of the test and per square meter of irradiated catalyst surface area.

### EXAMPLES

All of the examples carried out and of the results appear in table 1 below:

TABLE 1

| | | Fraction by | | Photocatalytic |
|---|---|---|---|---|
| | | volume of the | | activity over 20 |
| | Catalytic | semiconductor | Dilution | test hours |
| Example | bed | material a1-a4 | ratio | (mmol/m²) |
| 1 | a1 | 1 | 0% | 6 |
| (comparative) | | (without solid b1) | | |
| 2 | a1 + b1 | 0.75 of solid a1 + | 25% | 27 |
| | | 0.25 of solid b1 | | |
| 3 | a1 + b2 | 0.75 of solid a1 + | 25% | 5.6 |
| | | 0.25 of solid b2 | | |
| 4 | a2 | 1 | 0% | 65 |
| (comparative) | | (without solid b1) | | |
| 5 | a2 + b1 | 0.75 of solid a2 + | 25% | 262 |
| | | 0.25 of solid b1 | | |
| 6 | a3 | 1 | 0% | 2.3 |
| (comparative) | | (without solid B) | | |
| 7 | a3 + b1 | 0.75 of solid a3 + | 25% | 10 |
| | | 0.25 of solid b1 | | |
| 8 | a4 | 1 | 0% | 191 |
| (comparative) | | (without solid b1) | | |
| 9 | a4 + b1 | 0.75 of solid a4 + | 25% | 765 |
| | | 0.25 of solid b1 | | |

From this table, it is found that the photocatalytic activity of the “mixed” material combining the semiconductor material with structuring particles according to the invention is very markedly greater than that of a material consisting solely of the semiconductor material responsible for the photocatalytic activity of the material:

If the results of example 1 (comparative) and of example 2 are compared, it is seen that, with 25% less semiconductor material (example 2), the photocatalytic activity jumps, being multiplied by 4.5. Starting from another semiconductor (materials a2, a3, a4), a photocatalytic activity at the “start” is higher for a material 100% made of semiconductor, and the invention still manages to multiply it by a factor of at least 4 by combining it with structuring particles: example 9 thus achieves an impressive level of photocatalytic activity.

FIG. 5 represents, in the form of a graph, the results of examples 2 and 3. The fraction by volume of the particles made of TiO₂ is represented on the abscissa and the overall consumption of electrons over 20 h per square meter is represented on the ordinate. From this figure, it is seen that example 3 with the structuring particles b2 of too great a size gives results (the diamonds on the graph) which are much poorer than with example 2 using the structuring particles b1 (the circles on the graph), the size of which was calibrated to favor the Mie scattering.

This calibrating of the structuring particles is simple to choose and to obtain, and markedly more simple than to have to refine other parameters which are more complex to control of the macro- or microporosity of the material type.

It is seen that the invention is very flexible in its implementation: depending on the desired level of performance, depending on the items of equipment and the reactor chosen, it will be possible to adapt the composition of the material according to the invention by varying the choice of the materials, the dilution ratio and the way in which the mixing between the two materials will be carried out (mechanical mixing, chemical or physicochemical integration, and the like).

1. A catalytic bed comprising a particulate photocatalytic catalyst, characterized in that said bed comprises structuring particles made of mineral material b which are combined with at least one semiconductor material a having photocatalytic properties, the combination being produced
by mixing the structuring particles made of mineral material b with the semiconductor material a in the form of particles,
and/or by chemical or physicochemical deposition of the semiconductor material a on the structuring particles made of mineral material b,
the structuring particles b being essentially spherical in shape and having a mean diameter of between 22 nm and 8.0 μm, and preferably between 30 nm and 7.5 μm.

2. The catalytic bed as claimed in claim 1, characterized in that all of the particles within the bed are arranged in a disorganized manner.

3. The catalytic bed as claimed in claim 1, characterized in that, when the bed contains the semiconductor material a in the form of particles, said particles a exhibit a mean dimension of at most 100 nm, in particular of at most 50 nm, and of at least 5 nm, preferably of between 10 and 30 nm.

4. The catalytic bed as claimed in claim 1, characterized in that it exhibits a void ratio, equal to the ratio of the void volume in the photocatalytic bed to the total volume of the photocatalytic bed composed of voids and of particles, of at least 40%, preferably of at most 80% and in particular of between 40% and 70%.

5. The catalytic bed as claimed in claim 1, characterized in that it exhibits, in particular in the case of a chemical or physicochemical deposition of the semiconductor material a on the structuring particles made of mineral material b, a dilution ratio, equal to the ratio of the volume occupied by the structuring particles made of mineral material b to the volume occupied by the sum of the semiconductor material(s) a, a′ and of the structuring particles made of mineral material b, of at most 80%, in particular of between 5% and 70%, preferably of between 10% and 50%.

6. The catalytic bed as claimed in claim 1, characterized in that it comprises at least two distinct semiconductor materials, a first material a and a second material a′, and in that it is produced
by mixing structuring particles made of mineral material b with the semiconductor material(s) each in the form of particles of the first material a and of particles of the second material a′,
and/or by chemical or physicochemical deposition of the semiconductor materials a, a′ on the support particles b, either by deposition both of the first semiconductor material a and of the second semiconductor material a′ on the structuring particles b, or by deposition of the first semiconductor material a on a first part of the structuring particles b and of the second semiconductor material a′ on a second part of the structuring particles b.

7. The catalytic bed as claimed in claim 1, characterized in that the structuring particles made of mineral material b are made of metal oxide(s), in particular made of oxides of metals of groups II la and IVa of the periodic table, and preferably chosen from aluminum oxide, silicon oxide, a mixture of aluminum and silica oxides.

8. The catalytic bed as claimed in one of the preceding claims claim 1, characterized in that the/at least one of the semiconductor material(s) a, a′ comprises at least one of the following metal oxides: titanium oxide, tungsten oxide, cerium oxide, bismuth oxide, zinc oxide, copper oxide, vanadium oxide, iron oxide, cadmium oxide, and preferably is chosen from TiO₂, Bi₂O₃, CdO, Ce₂O₃, CeO₂, CeAlO₃, CuO, Fe₂O₃, FeTiO₃, ZnFe₂O₃, V₂O₅, ZnO, WO₃ and ZnFe₂O₄, alone or as a mixture.

9. The catalytic bed as claimed in claim 1, characterized in that the/at least one of the semiconductor material(s) a, a′ is doped with one or more ions chosen from metal ions, in particular ions of V, Ni, Cr, Mo, Fe, Sn, Mn, Co, Re, Nb, Sb, La, Ce, Ta, Ti, or from non-metal ions, in particular C, N, S, F, P, or by a mixture of metal and non-metal ions.

10. The catalytic bed as claimed in claim 1, characterized in that the/at least one of the semiconductor material(s) a, a′ also comprises one or more element(s) in the metallic state chosen from an element of groups IVb, Vb, VIb, VIIb, VIIIb, Ib, IIb, IIIa, IVa and Va of the periodic table of the elements and in direct contact with said semiconductor material, preferably from platinum, palladium, gold, nickel, cobalt, ruthenium, silver, copper, rhenium or rhodium.

11. A process for obtaining the catalytic bed as claimed in claim 1, characterized in that, on the one hand, the structuring particles of mineral material b and, on the other hand, the particles of semiconductor material a are mixed so as to produce a homogeneous distribution of the two types of particles within the bed.

12. A process for obtaining the catalytic bed as claimed in claim 1, characterized in that the or at least one of the semiconductor material(s) a, a′ is deposited on the structuring particles of mineral material b by impregnation of said structuring particles with a solution of at least one precursor of the semiconductor material, by ion exchange, by the electrochemical route of the type in particular with molten salts, then drying and optional calcination, by chemical vapor deposition, by spray drying or by atomic layer deposition.

13. A reactor (1) for the photocatalytic treatment of a feedstock in gaseous or liquid form and comprising at least one photocatalytic bed (2) as claimed in claim 1 and which is mounted in a fixed manner in said reactor.

14. A process for the photocatalytic treatment of a feedstock (7) in gaseous and/or liquid form, characterized in that:
at least one photocatalytic bed (2) as claimed in claim 1 is arranged in a fixed manner in a reactor (1),
said feedstock (7) is brought into contact in the reactor with the catalytic bed (2),
and the photocatalytic bed (2), during the contacting operation, is irradiated with at least one irradiation source (6) emitting in the UVA-A range and/or the UV-B range and/or the visible range, in particular in the wavelength range of between 220 and 800 nm, preferably in the range of between 300 and 750 nm.

15. The process as claimed in claim 1, characterized in that the photocatalytic treatment is:
a photo-oxidation of components present in a liquid or gaseous feedstock, in particular for the purposes of depollution/decontamination of the feedstock,
or a photocatalytic reduction of the CO₂ of a liquid or gaseous feedstock,
or a photolysis of the water of a liquid or gaseous feedstock, for the purposes of producing H₂.
